(19) United States
(12) Patent Application Publication
(10) Pub. No.: US 2010/0164916 A1
(43) Pub. Date: Jul. 1, 2010

(54) SOURCE DRIVER OF DISPLAY

(76) Inventors: Sang-Heon Lee, Songpa-gu (KR); Nam-Jin Song, Yongin-si (KR)

Correspondence Address: SHERR & VAUGHN, PLLC, 620 HERNDON PARKWAY, SUITE 320, HERNDON, VA, 20170, US

(21) Appl. No.: 12/647,332

(22) Filed: Dec. 24, 2009

(30) Foreign Application Priority Data
Dec. 26, 2008 (KR) 10-2008-0134232

(51) Int. Cl. G09G 5/00

(52) U.S. Cl. 345/205

(57) ABSTRACT

A source driver of a display including a timing controller, the source driver and a display panel may include a digital-to-analog converter configured to output an analog value corresponding to a digital data signal supplied from the timing controller of the display panel. An amplification unit is configured to amplify the analog value in a switched capacitor mode to produce an amplified result, and to output the amplified result as a driving signal for driving a unit column line of the display panel. Therefore, since area and power consumption can be further reduced compared with a related source driver, costs can be reduced and Electromagnetic Interference (EMI) can be improved by the reduction of power consumption.

The present application claims priority under 35 U.S.C. 119 to Korean Patent Application No. 10-2008-0134232 (filed on Dec. 26, 2008), which is hereby incorporated by reference in its entirety.

### BACKGROUND

Hereinafter, the general structure of a source driver included in a display will be described with reference to the accompanying drawings. FIG. 1 is a circuit diagram of a related source driver which includes an R-string 20, a switch box 30, a level shifter 40 and a buffer 50. For a detailed configuration and operation of the source driver shown in FIG. 1, reference may be made to Behzad Razavi, Design of Analog CMOS Integrated Circuits, New York: McGraw-Hill, 2001; and K. Martin and D. A. Johns, Analog Integrated Circuit Design, New York: Wiley, 1997. Accordingly, the detailed description of the detailed operation of the components shown in FIG. 1 will be omitted.

In the related source driver shown in FIG. 1, the level shifter 40 shifts the levels of data signals D₀ to D_{N-1} to levels which can drive the high-voltage switch box 30. This is because the switch box 30 cannot be driven by low level data signals D₀ to D_{N-1}. A source driver which necessarily requires the left shifter 40 occupies a large area.

In addition, as resolution is increased, the number of high-voltage transistors included in the switch box 30 is increased by (2N−1) and the number of level shifters 40 is increased by N. Therefore, as the resolution is increased, the size of the source driver is further increased.

Since a voltage gain of the buffer 50 connected to an output driving voltage Vₒᵤₜ is “1”, for example, in order to output the output driving voltage Vₒᵤₜ of 9V, the level of the supply voltage VDD1 should also be increased to about 9V. Also, the signals having the levels increased by the level shifter 40 are supplied to the switch box 30. For these reasons, the transistors configuring the switch box 30 should be high-voltage transistors. Therefore, the size of the switch box 30, with the larger sized high-voltage transistors, is also increased. As a result, since the related source driver shown in FIG. 1 has a complicated configuration, a large area and high power consumption are required.

### SUMMARY

Embodiments relate to a source driver of a display with a small area and low power consumption using the amplification principle of a switched capacitor mode. Embodiments relate to a source driver of a display which includes a timing controller, the source driver and a display panel. The source driver may include a digital-to-analog converter configured to output an analog value corresponding to a digital data signal supplied from the timing controller of the display panel. An amplification unit is configured to amplify the analog value in a switched capacitor mode to produce an amplified result, and to output the amplified result as a driving signal for driving a unit column line of the display panel.

Since the source driver of the display according to embodiments uses an amplifier in a switched capacitor mode mounted at an output side, unlike a related source driver using a unit buffer mounted at the output side, the following effects are obtained. First, since a supply voltage VDD2 having a level smaller than that of a supply voltage VDD1 used in the related source driver may be used, a switch box employing high-voltage transistors in the related art can employ low-voltage transistors and thus an area thereof can be reduced. Second, since a level shifter is not required unlike the related source driver using the level shifter, it is possible to further reduce power consumption and area. Third, since an operational amplifier is provided on the next stage of two Metal-Insulator-Metal (MIM) capacitors in an amplification unit in a switched capacitor mode, it is possible to further reduce the area of the source driver.

Therefore, since an area and power consumption can be further reduced compared with the related source driver as described above, cost can be reduced and Electromagnetic Interference (EMI) can be improved by the reduction of power consumption.

### DRAWINGS

FIG. 1 is a circuit diagram of a general source driver.

Example FIG. 2 is a circuit diagram of a source driver according to embodiments.

Example FIGS. 3A and 3B are views showing a state in which first to fifth switches shown in example FIG. 2 are turned on/off in response to a switching signal and an inverted switching signal.

### DESCRIPTION

Hereinafter, the schematic configuration and the operation of a display will be described prior to the description of embodiments. In general, the display includes a timing controller, a plurality of source drivers (or column driving circuits) and gate drivers (or row driving circuits), and a display panel. The timing controller controls the gate drivers and the source drivers, and the gate drivers and the source drivers drive the display panel. The display panel displays an image according to scanning signals R₁ to Rₙ supplied from the gate drivers and data signals C₁ to Cₘ supplied from the source drivers. The display may include various display panels, which can be used between the timing controller and a display driving integrated circuit, such as a Liquid Crystal Display (LCD) panel (for example a Thin-Film Transistor (TFT) LCD, a Super Twisted Nematic (STN)-LCD), a Ferroelectric Liquid Crystal Display (FLCD), a Plasma Display Panel (PDP), an Organic Luminescence Electro Display (OLED) panel, or a Field Emission Display (FED). The timing controller can transmit various control signals for controlling the source driver and data to the source driver.

Hereinafter, a source driver of a display according to embodiments will be described with reference to the accompanying drawings. Example FIG. 2 is a circuit diagram of a source driver according to embodiments. The source driver shown in example FIG. 2 may include a Digital-to-Analog Converter (DAC) 60 and an amplification unit 70. The DAC 60 may generate an analog value corresponding to N digital data signals D0 to DN−1 supplied from the timing controller, and output the generated analog value to the amplification unit 70.

The DAC 60 may be implemented by a voltage divider 62 and a decoder 64. The voltage divider 62 divides a supply voltage VDD2 into n voltages having different levels and outputs the divided n voltages having the different levels to the decoder 64. The voltage divider 62 may be implemented by n string resistors R₀ to Rₙ₋₁ connected between the supply voltage VDD2 and ground in series.

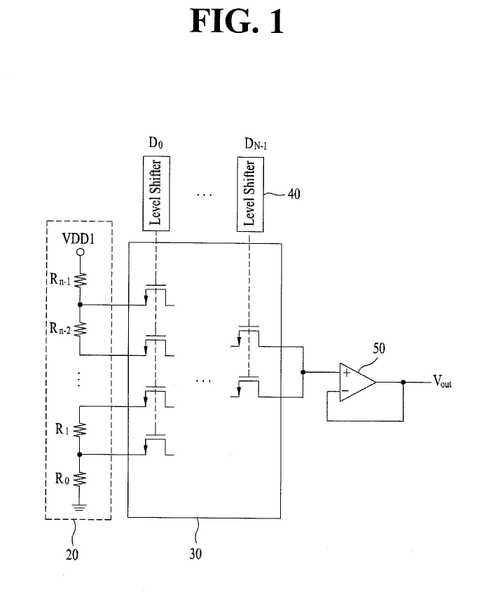

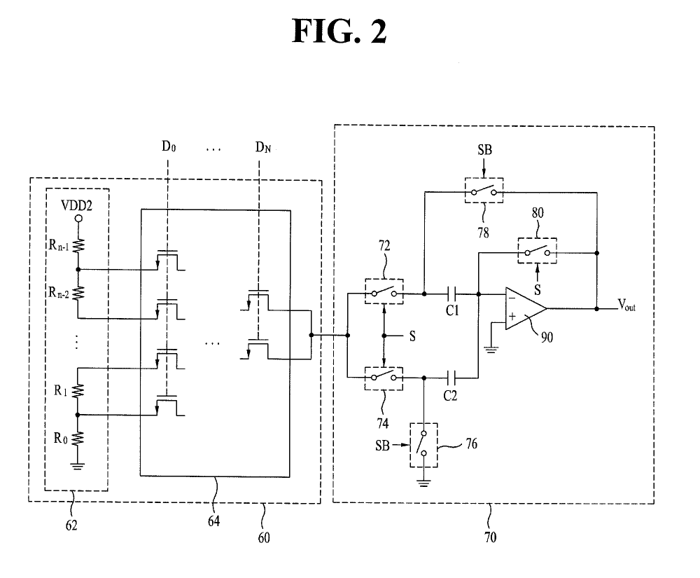

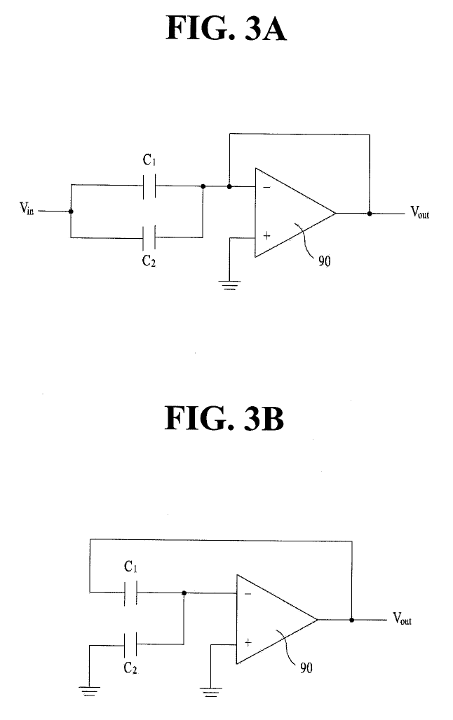

The decoder 64 may decode the n voltages having the different levels supplied from the voltage divider 62 in response to the digital data signals D₀ to D_{N-1} and output the decoded result to the amplification unit 70 as an analog value. The decoder 64 may be implemented by the switch box 64 having a plurality of switches which are switched to convert the n voltages having the different levels into the analog value in response to the digital data signals D₀ to D_{N-1}. The switches of the switch box 64 may be implemented by MOS transistors as shown in example FIG. 2. According to embodiments, the MOS transistors may be low-voltage transistors unlike high-voltage transistors included in the switch box 30 shown in FIG. 1. For example, the MOS transistors may be NMOS, PMOS or CMOS transistors.

Meanwhile, the amplification unit 70 amplifies the analog value (for example, analog voltage) supplied from the DAC 60 in a switched capacitor mode and outputs the amplified result as a driving signal Vₒᵤₜ for driving a unit column line of the display panel. In general, amplifiers in a switched capacitor mode have capacitors. Accordingly, the analog voltage output from the DAC 60 may be amplified to a desired value and output as the output voltage Vₒᵤₜ by adjusting the values of the capacitors included in the amplification unit 70.

The components of the amplification unit 70 shown in example FIG. 2 are only exemplary and embodiments are not limited to such a circuit configuration. For example, if the analog voltage is amplified by the capacitor values so as to output the output driving voltage Vₒᵤₜ, the circuit may have an alternate configuration.

According to embodiments, the amplification unit 70 shown in example FIG. 2 includes first to fifth switches 72 to 80, first and second capacitors C1 and C2, and an operational amplifier 90. The configuration of the components included in the amplification unit 70 will now be described.

The operational amplifier 90 may have a negative input terminal (−) connected to one side of each of the first and second capacitors C1 and C2, an output terminal connected to the driving signal Vₒᵤₜ, and a positive input terminal (+) connected to ground.

The first capacitor C1 may be connected between the negative input terminal (i.e., the inverting input denoted by “−”) of the operational amplifier 90 and the first switch 72. The second capacitor C2 may be connected between the negative input terminal (−) of the operational amplifier 90 and the second switch 74.

The first switch 72 may be connected to the first capacitor C1 and the output terminal of the DAC 60, and may be switched in response to a switching signal S. The second switch 74 may be connected between the second capacitor C2 and the output terminal of the DAC 60, and may be switched in response to the switching signal S. The third switch 76 may be connected between a contact point between the second switch 74 and the second capacitor C2 and ground and may be switched in response to an inverted switching signal SB. The fourth switch 78 may be connected between a contact point between the first switch 72 and the first capacitor C1 and the output terminal of the operational amplifier 90 and may be switched in response to the inverted switching signal SB. The fifth switch 80 may be connected between the negative input terminal (−) and the output terminal of the operational amplifier 90 and may be switched in response to the switching signal S.

The principle of operation of the amplification unit 70 having the above-described configuration will now be described. Example FIGS. 3A and 3B are views showing a state in which the first to fifth switches 72 to 80 shown in example FIG. 2 are turned on/off in response to the switching signal S and the inverted switching signal SB.

First, if the switching signal S is at a “High” logic level and the inverted switching signal SB is at a “Low” logic level, the connection structure of the amplification unit 70 shown in example FIG. 2 is obtained as shown in example FIG. 3A. If the switching signal S is at a “Low” logic level and the inverted switching signal SB is at a “High” logic level, the connection structure of the amplification unit 70 shown in example FIG. 2 shown in example FIG. 3B is obtained.

A variation in quantity Q of electric charge charged in the capacitors C1 and C2 in the connection structure shown in example FIG. 3A and a variation AQ in quantity Q of electric charge stored in the capacitors C1 and C2 in the connection structure shown in example FIG. 3B are equal as shown in Equation 1. This is based on the law of conservation of charge.

ΔQ1=ΔQ2 Equation 1

Equation 1 is expressed by Equation 2.

Q1(S=L)−Q1(S=H)=Q2(S=L)−Q2(S=H) Equation 2

where, S=L indicates that the switching signal is at the “Low” logic level and S=H indicates that the switching signal is at the “High” logic level. Accordingly, as shown in Equation 3, it can be seen that the analog value Vᵢₙ output from the DAC 60 is amplified so as to generate the output voltage Vₒᵤₜ which is the driving signal.

$${V}_{out} = \frac{C 1 + C 2}{C 1} \times {V}_{in} \qquad Equation 3$$

It can be seen from Equation 3 that a voltage gain (Vₒᵤₜ/Vᵢₙ) can be adjusted by adjusting the values of the capacitors C1 and C2.

In the source driver according to embodiments, the amplifier 70 of the switched capacitor mode may be provided at the output side of the source driver, instead of a unit buffer 50. Therefore, a supply voltage VDD2 having a level smaller than that of the supply voltage VDD1 used for driving the R-string 20 in the related source driver shown in FIG. 1 may be used. For example, the general supply voltage VDD1 is 9 volts, but the supply voltage VDD2 shown in FIG. 2 need only be 3 volts.

In addition, the transistors included in the switching box 30 shown in FIG. 1 are high-voltage transistors, but the transistors for implementing the switching box 64 shown in example FIG. 2 do not need to be high-voltage transistors and, instead, the low-voltage transistors are sufficient. Since the size of the low-voltage transistor is smaller than that of the high-voltage transistor, the switch box 64 of the source driver shown in example FIG. 2 according to embodiments may be smaller than that of the switch box 30 shown in FIG. 1.

In addition, the related source driver shown in FIG. 1 uses the level shifter 40, but the source driver according to embodiments does not require the level shifter 40. Accordingly, it is possible to further reduce the size and power consumption of the source driver. In addition, since the operational amplifier 90 is provided on the next stage of the two Metal-Insulator-Metal (MIM) capacitors C1 and C2, it is possible to further reduce the area of the source driver.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a digital-to-analog converter configured to output an analog value corresponding to a digital data signal supplied from a timing controller of a display panel; and
an amplification unit configured to amplify the analog value in a switched capacitor mode to produce an amplified result, and to output the amplified result as a driving signal for driving a unit column line of the display panel.

2. The apparatus of claim 1, wherein the digital-to-analog converter includes a voltage divider configured to divide and output a supply voltage into n voltages having different levels.

3. The apparatus of claim 2, wherein the voltage divider includes n resistors connected between the supply voltage and ground in series.

4. The apparatus of claim 2, wherein the digital-to-analog converter includes a decoder configured to decode the n voltages having the different levels supplied from the voltage divider in response to the digital data signal and to output the decoded result as the analog value.

5. The apparatus of claim 4, wherein the decoder includes a switch box including a plurality of switches.

6. The apparatus of claim 5, wherein the switch box is configured to convert the n voltages into the analog value in response to the digital data signal.

7. The apparatus of claim 5, wherein the switches of the switch box are MOS transistors.

8. The apparatus of claim 7, wherein the MOS transistors are low-voltage transistors.

9. The apparatus of claim 7, wherein the MOS transistors are NMOS, PMOS or CMOS transistors.

10. The apparatus of claim 1, wherein the amplification unit includes an operational amplifier having an output terminal connected to the driving signal and a positive input terminal connected to ground.

11. The apparatus of claim 10, wherein the amplification unit includes a first capacitor having one side connected to a negative input terminal of the operational amplifier.

12. The apparatus of claim 11, wherein the amplification unit includes a second capacitor having one side connected to the negative input terminal.

13. The apparatus of claim 12, wherein the amplification unit includes a first switch connected between the other side of the first capacitor and the analog value.

14. The apparatus of claim 13, wherein the amplification unit includes a second switch connected between the other side of the second capacitor and the analog value.

15. The apparatus of claim 14, wherein the first switch and the second switch are switched in response to the switching signal.

16. The apparatus of claim 15, wherein the amplification unit includes a third switch connected between a contact point between the second switch and the second capacitor and ground.

17. The apparatus of claim 16, wherein the amplification unit includes a fourth switch connected between a contact point between the first switch and the first capacitor and the output terminal.

18. The apparatus of claim 17, wherein the third switch and the fourth switch are switched in response to an inverted switching signal.

19. The apparatus of claim 18, wherein the amplification unit includes a fifth switch connected between the negative input terminal and the output terminal.

20. The apparatus of claim 19, wherein the fifth switch is switched in response to the switching signal.
